(19) United States
(12) Patent Application Publication
(10) Pub. No.: US 2026/0088581 A1
(43) Pub. Date: Mar. 26, 2026

(54) ADAPTER FOR LEAD WIRE CONNECTION

(71) Applicant: Curbell Medical Products, Inc., Orchard Park, NY (US)

(72) Inventor: Joel Jusiak, Holland, NY (US)

(21) Appl. No.: 19/339,194

(22) Filed: Sep. 24, 2025

Related U.S. Application Data
(60) Provisional application No. 63/698,108, filed on Sep. 24, 2024.

(51) Int. Cl. H01R 27/00; H01R 13/05; H01R 13/10; H01R 13/627; H01R 13/631; H01R 31/06

(52) U.S. Cl. CPC H01R 27/00; H01R 13/052; H01R 13/10; H01R 13/6277; H01R 13/6315; H01R 31/06; H01R 2201/12

(57) ABSTRACT

An adapter for electrocardiogram (ECG) lead wire connectors is disclosed.

Embodiments of the adapter are configured to interface with multiple connector types, including, for example, tab electrodes, snap electrodes, pinch connectors, and banana plugs. In various embodiments, it includes a clamp connector with a locking tab for tab electrodes, a snap receptacle (snap connector) for receiving snap electrodes, and a dock end having a button terminal and a lead wire retainer. The button terminal is configured to receive snap or pinch connectors, while the lead wire retainer maintains stable contact by limiting displacement along the y-axis and permitting rotation in the xz plane. A banana connector receptacle may also be provided for compatibility with banana plugs. The adapter enhances connector stability during patient movement and improves interoperability across ECG systems.

### CROSS REFERENCE TO RELATED APPLICATIONS

This application claims priority to U.S. Provisional Application No. 63/698,108, filed on Sep. 24, 2024, now pending, the disclosure of which is incorporated herein by reference.

### FIELD OF THE DISCLOSURE

The present disclosure relates to lead wires for electrocardiograms (ECGs), and more particularly to connectors for such lead wires.

### BACKGROUND OF THE DISCLOSURE

Electrocardiogram (ECG) monitoring is a critical diagnostic tool used to assess cardiac function in clinical and emergency settings. ECG systems typically rely on multiple lead wires that connect electrodes placed on a patient's body to monitoring equipment. These lead wires may terminate in various connector types, including, for example, tab electrodes, snap connectors, pinch connectors, and banana plugs. However, the diversity of connector formats across different equipment manufacturers and clinical environments often leads to compatibility challenges.

Existing solutions for adapting between connector types are limited in flexibility and may require multiple adapters or modifications, which can compromise signal integrity or increase the risk of disconnection during patient movement. Moreover, conventional adapters may not adequately secure the lead wire connectors, especially when subjected to axial or rotational forces, leading to unreliable contact and potential data loss.

There is a need for a universal adapter that can interface with multiple ECG lead wire connector types while maintaining secure and stable electrical contact.

### BRIEF SUMMARY OF THE DISCLOSURE

The present disclosure provides an adapter (sometimes referred to as an adapter clip) for electrocardiogram (ECG) lead wire connectors that enables secure and versatile interfacing between various connector types used in clinical monitoring systems. In some embodiments, the adapter is configured to couple with tab electrodes, snap electrodes, and banana plugs, and includes a dock end designed to receive lead wires terminating in snap or pinch connectors.

In some embodiments, the adapter features a lead wire retainer that maintains stable electrical contact by limiting displacement of the lead wire connector in certain directions (e.g., axially with respect to a snap connector insertion direction). This configuration reduces the likelihood of accidental disconnection due to patient movement or tension on the lead wires. The adapter may include a clamp connector with a locking tab, a snap receptacle, and a banana connector receptacle, all integrated into a compact body with ergonomic and mechanical features that enhance usability and reliability.

The adapter may be formed from biocompatible materials. The adapter may include resilient and/or rigid components depending on the desired retention behavior. The disclosed adapter improves compatibility across ECG systems and enhances the stability of lead wire connections in dynamic clinical environments.

### DESCRIPTION OF THE DRAWINGS

For a fuller understanding of the nature and objects of the disclosure, reference should be made to the following detailed description taken in conjunction with the accompanying drawings, in which:

FIG. 1A is a view of an adapter according to an embodiment of the present disclosure;

FIG. 1B is another view of the adapter of FIG. 1A;

FIG. 1C is a bottom perspective view of the adapter of FIGS. 1A-1C;

FIG. 2A is a view of the adapter of FIGS. 1A-1C, wherein a locking tab is in an open position to allow insertion of a tab electrode;

FIG. 2B is another view of the adapter of FIG. 2A with the locking tab in the open position;

FIG. 3A is a view of an adapter of the present disclosure shown in proximity to a pinch connector of a lead wire;

FIG. 3B is a view of the adapter of FIG. 3A wherein the pinch connector is coupled with the button terminal of the adapter;

FIG. 4A is a view of an adapter of the present disclosure shown in proximity to a snap connector of a lead wire;

FIG. 4B is a view of the adapter of FIG. 4A wherein the snap connector is coupled with the button terminal of the adapter;

FIG. 4C is a perspective view of the adapter of FIGS. 4A and 4B, showing the bottom side of the adapter and the snap connector of the lead wire;

FIG. 4D is a side view of the adapter of FIGS. 4A-4C showing the snap connector inserted in the dock end of the adapter and retained by the lead wire retainer;

FIG. 5A is a view of an adapter according to the present disclosure shown in proximity to a banana plug of a lead wire; and

FIG. 5B is a view of the adapter of FIG. 5A, wherein the banana plug is shown inserted in the banana receptacle of the adapter.

### DETAILED DESCRIPTION OF THE DISCLOSURE

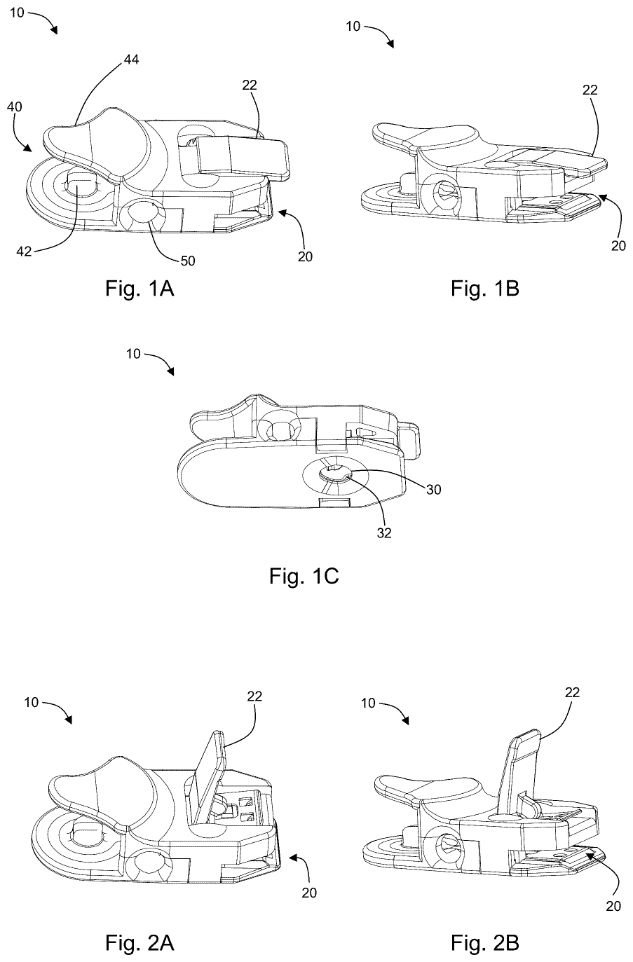

With reference to FIGS. 1A-1C, the present disclosure may be embodied as an adapter 10 for lead wire connectors. For example, the adapter may be useful for adapting between different types of ECG lead wire end connectors (e.g., snap connectors, pinch connectors, banana plugs, etc.) to ECG electrode connectors (e.g., tab electrodes, snap electrodes, etc.) The adapter 10 includes a clamp connector 20 configured to couple with a tab electrode. The clamp connector 20 may include a locking tab 22 having an open position (shown in FIGS. 2A and 2B) allowing insertion of a tab electrode, and a closed (locked) position (shown in FIGS. 1A and 1B) for retaining the tab electrode once inserted. The adapter 10 includes a snap receptacle 30 (e.g., female portion of a snap connector) configured to be coupled with a snap electrode (e.g., a male portion of a snap connector of an ECG electrode).

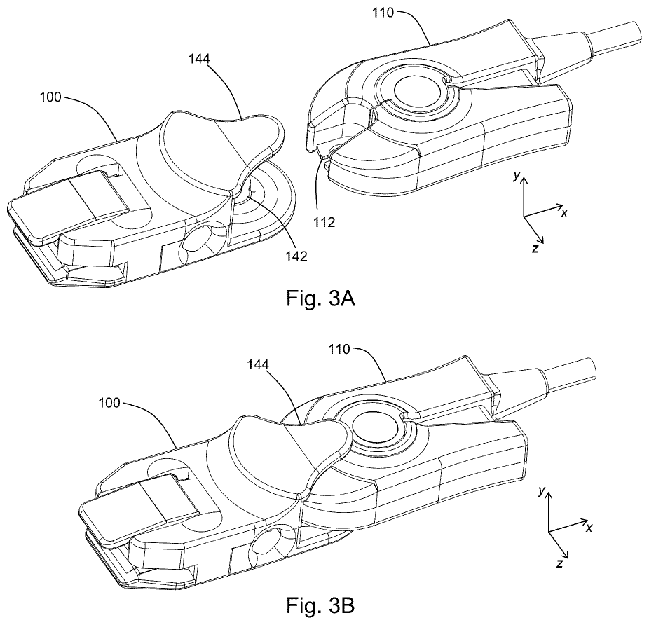

The adapter has a dock 40 having a button terminal 42. The button terminal 42 is configured to receive lead wires having snap connectors and pinch connectors. For example, FIG. 3A shows an adapter 100 of the present disclosure and an end of a lead wire having a pinch connector 110. FIG. 3B shows the pinch connector 110 connected to the adapter 100 (i.e., the pinch 112 of the pinch connector 110 is coupled to the button terminal 142 of the adapter 100). The dock 40 of the adapter includes a lead wire retainer 144 configured to maintain the lead wire connector on the button terminal. In this way, the pinch connector is urged to maintain connection to the adapter and is less likely to be inadvertently disconnected by, for example, movement of a patient. The lead wire retainer 144 limits movement in the xy/zy plane keeping the lead wire connector 110 in contact with button terminal 142 reducing the possibility of a disconnection (open) when the lead wire is pulled in the y direction. The lead wire retainer 144 allows for lead wire connector 110 rotation in the xz plane (about a y axis) reducing forces on the installed electrode during patient movement or repositioning.

In various embodiments, the lead wire retainer is formed from a resilient material. As used herein, “resilient material” refers to a substance capable of undergoing elastic deformation under stress and returning to its original shape upon removal of the stress. This property allows the retainer to flex during insertion of a lead wire connector-such as a snap or pinch connector-and then return to a retaining position that securely holds the connector in place. The resilience of the material contributes to the adapter's ability to maintain electrical contact while minimizing the risk of accidental disconnection. Non-limiting examples of suitable resilient materials include medical-grade polymers such as silicone, thermoplastic elastomers (TPE), or polyurethane, which offer both flexibility and durability under repeated use and patient movement.

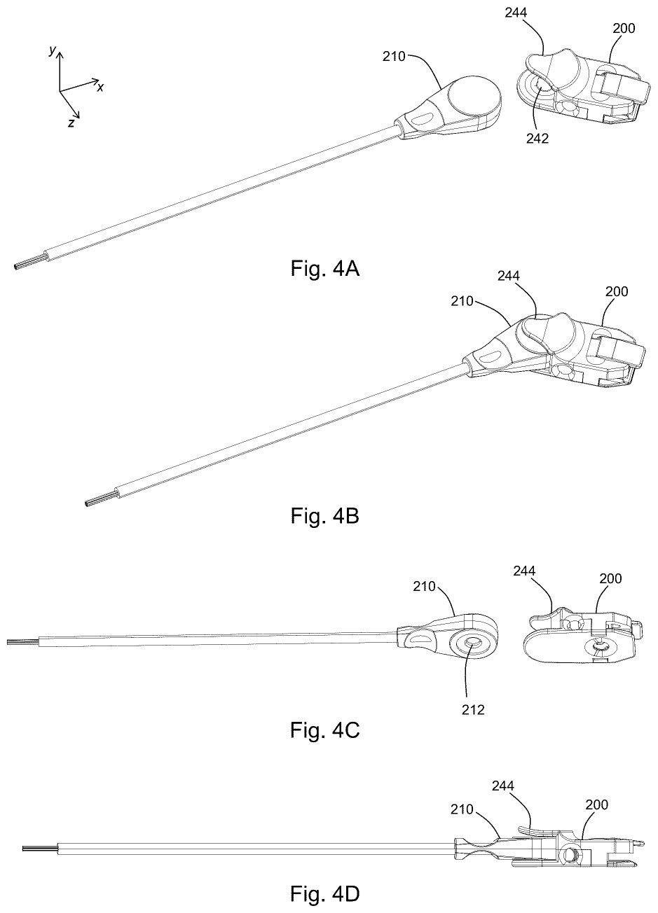

FIG. 4A shows an adapter 200 of the present disclosure and an end of a lead wire having a snap connector 210. FIG. 4B shows the snap connector 210 connected to the adapter 200 (i.e., the snap receptacle 212 of the snap connector 110 is coupled to the button terminal 242 of the adapter 200). The lead wire retainer 244 is shown engaging with the snap connector end of the lead wire to maintain the lead wire connector on the button terminal. The lead wire retainer 244 limits movement in the xy/zy plane keeping the lead wire connector 210 in contact with button terminal 242 reducing the possibility of a disconnection (open) when the lead wire is pulled in the y direction. The lead wire retainer 244 allows for lead wire connector 210 rotation about the y axis in the xz plane reducing forces on the installed electrode during patient movement or repositioning. FIGS. 4A-4C show how the lead wire may swivel when connected to the adapter (i.e., the angle formed by the lead wire and an axis of the adapter may vary.

In some embodiments, the lead wire retainer 244 may include a sloped geometry designed to facilitate guided connection of the snap connector 210. Such a sloped surface may provide a tapered entry path that aligns the snap connector with the button terminal during insertion. This geometry reduces the likelihood of misalignment and enables smoother engagement by directing the connector into its seated position with reduced resistance. The slope may be formed as an angled ramp or curved contour, and may be integrated into one or more surfaces of the retainer that interact with the connector body. By guiding the connector into place, the sloped geometry enhances usability and contributes to consistent electrical contact during clinical use.

In some embodiments, the button terminal may be implemented as a pogo pin. The button terminal may include a spring-loaded conductive contact that maintains pressure against the lead wire connector to ensure reliable electrical engagement. In other embodiments, the button terminal may be formed from spring steel, allowing elastic deformation during connector insertion and returning to its original shape to retain the connector. These configurations enhance contact stability and accommodate repeated use without mechanical degradation.

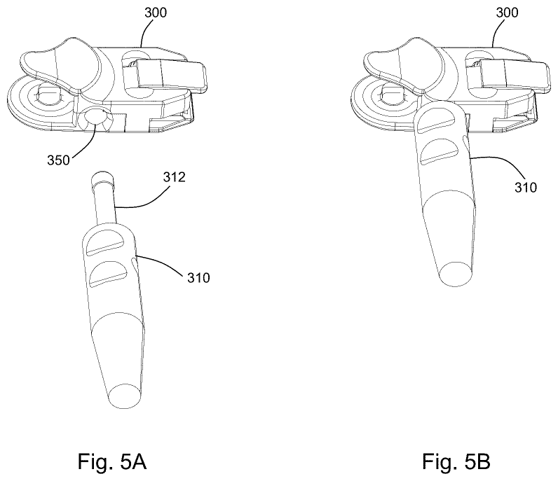

In some embodiments, the adapter 10 further includes a banana connector receptacle 50 configured to be coupled with a banana plug of a lead wire. FIG. 5A shows an adapter 300 of the present disclosure and an end of a lead wire having a banana connector 300. The adapter 300 has a banana connector receptacle 350 configured to receive the banana plug 312 of the banana connector 310 (as shown in FIG. 5B).

In some embodiments, the snap receptacle 30 of the adapter includes a detent 32 configured to secure the snap electrode upon insertion. The detent may include one or more inwardly biased projections or recesses that engage with a corresponding ridge or groove on a snap connector. When the snap electrode is pressed into the receptacle, the detent temporarily deforms to allow entry and then returns to its original position to lock the connector in place.

This engagement provides tactile feedback to the user and ensures a secure mechanical and electrical connection. The detent reduces the likelihood of accidental disconnection due to vibration, patient movement, or handling, thereby improving the reliability of ECG signal acquisition.

Although the present disclosure has been described with respect to one or more particular embodiments, it will be understood that other embodiments of the present disclosure may be made without departing from the spirit and scope of the present disclosure.

What is claimed is:

1. An adapter for lead wire connectors, comprising:
a clamp connector configured to be coupled with a tab electrode;
a snap receptacle configured to be coupled with a snap electrode; and
a dock end having a button terminal and a lead wire retainer, wherein the button terminal is configured to receive a lead wire connector having a snap connector or a pinch connector, and wherein the lead wire retainer is configured to maintain a lead wire connector on the button terminal.

2. The adapter of claim 1, further comprising a banana connector receptacle for receiving a banana plug.

3. The adapter of claim 1, further comprising a body having a first end, wherein the clamp connector and snap receptacle are located at the first end of the body.

4. The adapter of claim 3, wherein the body further has a second end, wherein the dock end and lead wire retainer are located at the second end of the body.

5. The adapter of claim 1, wherein the lead wire retainer is made from a resilient material.

6. The adapter of claim 1, wherein the lead wire retainer is configured to be flexed to allow a snap connector to be connected to the button terminal, and return to retain the snap connector onto the button terminal.

7. The adapter of claim 1, wherein the lead wire retainer is configured to be rigid and the button terminal is configured to be flexed to allow a snap connector to be connected to the button terminal, and return to retain the snap connector onto the button terminal.

8. The adapter of claim 1, wherein the button terminal comprises a pogo pin or is formed from spring steel.

9. An adapter for ECG lead wires, comprising:
a body having a first end and a second end;
a clamp connector located at the first end; and
a dock located at the second end, the dock comprises a button terminal and a lead wire retainer, wherein the lead wire retainer is configured to engage with a lead wire connector and maintain axial alignment during patient movement.

10. The adapter of claim 9, further comprising a snap receptacle on a patient-facing side of the body.

11. The adapter of claim 9, wherein the lead wire retainer is configured to reduce axial displacement of the lead wire connector.

12. The adapter of claim 9, wherein the button terminal is formed of a conductive material and includes a spring-loaded contact surface.

13. The adapter of claim 9, wherein the snap receptacle includes a detent to secure the snap electrode.

14. The adapter of claim 9, wherein the button terminal comprises a pogo pin or is formed from spring steel.
